(19) United States
(12) Patent Application Publication
(10) Pub. No.: US 2026/0246773 A1
(43) Pub. Date: Aug. 20, 2026

(54) CENTRALIZED ACCESS TOKEN MANAGEMENT IN A DISTRIBUTED SERVICE COMPUTING ARCHITECTURE

(71) Applicant: FMR LLC, Boston, MA (US)

(72) Inventor: Anand Krishnamoorthy, Chennai (IN)

(21) Appl. No.: 19/058,335

(22) Filed: Feb. 20, 2025

(51) Int. Cl. H04L 9/40

(52) U.S. Cl. CPC H04L 63/0846

(57) ABSTRACT

Methods and systems for centralized access token management in a distributed service computing architecture include a token management node that generates an access token for each of a plurality of application services by requesting the access tokens from an authentication service node via a software interface using authentication credentials associated with each of the application services and storing the access tokens in a credentials management node. The token management node provides the access tokens to the application services upon request, including receiving an access token request from a first application service and transmitting a first access token in response. Upon receiving the first access token, the first application service transmits an access request that includes the first access token to an application resource node. Upon receiving the access request, the application resource node provides resources identified in the access request to the first application service.

### TECHNICAL FIELD

This application relates generally to methods and apparatuses, including computer program products, for centralized access token management in a distributed service computing architecture.

### BACKGROUND

Many distributed computing architectures that service a large number of users and client devices aim to provide fast and efficient processing of application software functions and/or data provided by backend application resources, including managing requests from application services and endpoint computing devices. As can be appreciated, some applications provided by distributed computing architectures require real-time or near real-time responsiveness to user requests—such as equity trading platforms that serve tens of millions of users. Key performance goals for such systems include low network and transaction latency, high uptime and service availability, and scalability of processing and service bandwidth.

However, it can be difficult to achieve these performance goals in distributed computing systems while also ensuring the implementation of robust security via an authentication framework, such as Open Authentication 2.0 (OAuth 2.0). In one example, authentication is performed by generating and storing access tokens during the processing of access requests received from application services and endpoints—which can require multiple additional application programming interface (API) calls to various services. In this scenario, the additional API calls lead to delay in completing the authentication process, as well as imposing increased processing requirements on the network and computing system. In addition, certain APIs may have limits on the number of calls that can be made in a given timeframe, and exceeding these limits can result in the API calls being blocked. For applications that require high responsiveness and scalability, these issues and limitations have a detrimental impact on system performance and user satisfaction.

### SUMMARY

Therefore, what is needed are improved computer methods and systems for centralized access token management in a distributed service computing architecture. The techniques described herein beneficially provide for a sidecar API that is attached to a token manager and a credentials manager, where the token manager and sidecar API can handle the tasks of access token generation, rotation, and management independently from the processing of authentication requests and access requests for application services. The approach described in this application enables the significant technical benefits of (i) reducing the number of API calls required for authentication of an application service during processing of an access request, which in turn reduces network overhead and processor usage; (ii) simplifying the development and deployment of specific API services by eliminating the need to incorporate token generation and storage functions; (iii) proactively caching and rotating access tokens before expiration to ensure uninterrupted service performance; and (iv) leveraging specialized token/secret management capabilities of existing secret management platforms.

The invention, in one aspect, features a system for centralized access token management in a distributed service computing architecture. The system comprises a plurality of application services, each application service associated with a different application, an authentication service node, a token management node, a credentials management node, a software interface for connecting the token management node to the credentials management node, and a plurality of application resource nodes. The token management node generates an access token for each of the plurality of application services by requesting the access tokens from the authentication service node via the software interface using one or more authentication credentials associated with each of the application services. The token management node stores the access tokens in a credentials management node. The credentials management node provides the stored access tokens to each of the plurality of application services upon request, including receiving an access token request from a first one of the application services and transmitting a first access token associated with the first application service in response to the access token request. Upon receiving the first access token from the credentials management node, the first application service transmits an access request to one of the application resource nodes that includes the first access token. Upon receiving the access request from the first application service, the application resource node provides one or more resources identified in the access request to the first application service.

The invention, in another aspect, features a computerized method of centralized access token management in a distributed service computing architecture. A token management node generates an access token for each of a plurality of application services by requesting the access tokens from an authentication service node using one or more authentication credentials associated with each of the application services. The token management node stores the access tokens in a credentials management node using a software interface that connects the token management node to the credentials management node. The credentials management node provides the stored access tokens to each of the plurality of application services upon request, including receiving an access token request from a first one of the application services and transmitting a first access token associated with the first application service in response to the access token request. Upon receiving the first access token from the credentials management node, the first application service transmits an access request to one of the application resource nodes that includes the first access token. Upon receiving the access request from the first application service, the application resource node provides one or more resources identified in the access request to the first application service.

Any of the above aspects can include one or more of the following features. In some embodiments, the token management node generates and stores the access tokens for each of the plurality of application services independently from the credentials management node receiving the access token requests from the application services. In some embodiments, the token management node generates the access tokens periodically according to a defined schedule using authentication credentials stored in the credentials management node.

In some embodiments, upon receiving the access request from the first application service, the application resource node validates the first access token prior to providing the one or more resources identified in the access request to the first application service. In some embodiments, the application resource node validates the first access token by transmitting a validation request including the first access token to the authentication service node.

In some embodiments, the token management node periodically rotates each of the access tokens stored in the credentials management node by generating a new access token for each of the plurality of application services, where the token management node requests the new access token from the authentication service node via the software interface using the one or more authentication credentials associated with each of the application services and stores the new access tokens in the credentials management node. In some embodiments, the token management node periodically determines whether each of the access tokens stored in the credentials management node will expire based upon a timestamp associated with each of the access tokens. In some embodiments, when the token management node determines that an existing access token stored in the credentials management node will expire, the token management node deletes the existing access token from the credentials management node and generates a new access token by requesting the new access token from the authentication service node.

In some embodiments, the one or more authentication credentials associated with each of the application services comprise a client identifier and a client secret. In some embodiments, the one or more authentication credentials associated with each of the application services are stored in the credentials management node in isolation from the application service. In some embodiments, the access tokens are stored as key-value pairs in the credentials management node. In some embodiments, the access tokens are stored as JavaScript Object Notation (JSON) data including one or more of a timestamp, a token validity, and an environment.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for centralized access token management in a distributed service computing architecture.

FIG. 2 is a flow diagram of a computerized method of centralized access token management in a distributed service computing architecture.

FIG. 3 is a diagram of an exemplary storage area in credentials manager for authentication credentials and access tokens.

FIG. 4 is a ladder diagram of a computerized workflow for generation and storage of access tokens.

FIG. 5 is a ladder diagram of a computerized workflow for accessing application resources using a cached access token.

FIG. 6 is a ladder diagram of a computerized workflow for refreshing cached access tokens.

### DETAILED DESCRIPTION

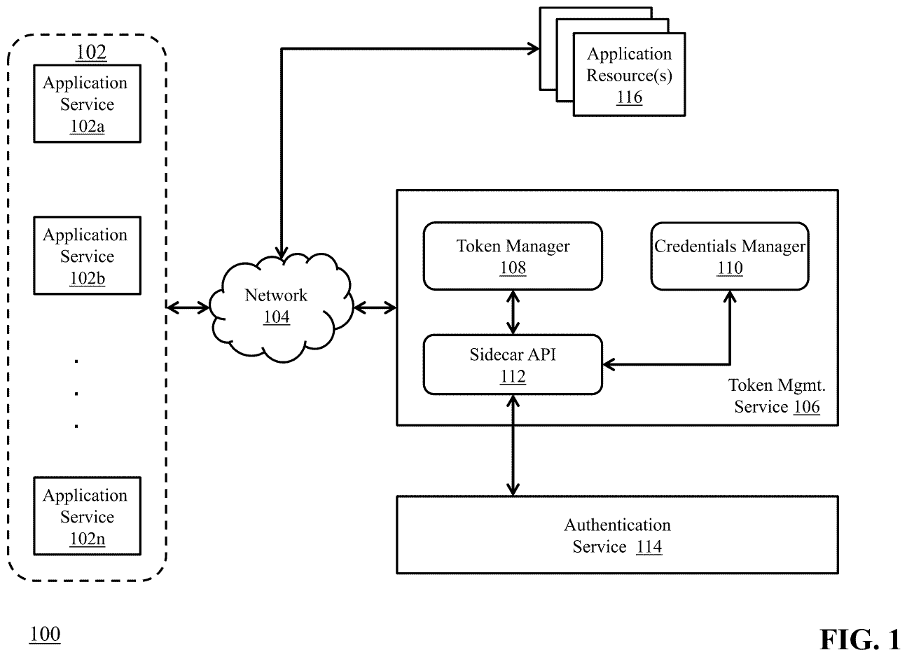

FIG. 1 is a block diagram of system 100 for centralized access token management in a distributed service computing architecture. System 100 includes a plurality of application services 102a-102n (collectively, application services 102), communication network 104, token management service 106 that includes token manager 108, credentials manager 110, and sidecar application programming interface (API) 112, authentication service 114, and application resources 116.

Application services 102a-102n comprise logical computing devices (e.g., cloud-based computing containers) and/or physical computing devices (e.g., server computers) that are configured to provide software application functionality to remote computing devices, such as application servers and/or endpoint computing devices (e.g., client devices operated by users of system 100). Examples of application services 102 include, but are not limited to, single page applications (Angular, React) and backend services (e.g., NodeJs, .NET Core). Examples of application servers or endpoint computing devices include, but are not limited to, desktop computers, laptop computers, tablets, mobile devices, smartphones, web application servers, cloud-based computing systems, database management platforms, software-as-a-service (SaaS) platforms, sysadmin control devices, and the like.

In some embodiments, application servers and/or endpoint computing devices can establish a connection to one or more application services 102, e.g., via an API, browser application software, or native application software installed on the remote computing device. In the case of client endpoint devices, the user at the endpoint computing device can interact with (e.g., browse) applications provided by application services 102 by, e.g., activating links or other input elements and navigating through various functions and interfaces of the applications provided by application services 102. In some embodiments, an endpoint computing device can provide a graphical user interface (GUI) via a display device that is configured to receive input from a user of the endpoint device and to present output (e.g., display content) to that user. It should be appreciated that system 100 can comprise any number of application services 102. It should be appreciated that other types of computing devices that are capable of connecting to the components of system 100 can be used without departing from the scope of invention.

As mentioned above, communication network 104 enables application services 102 to communicate with token management service 106 for the purpose of centralized access token management in a distributed service computing architecture, including token generation, token rotation, token invalidation, and application service authentication, as described herein. Network 104 also enables application services 102 to communicate with application resources 116 for the purpose of accessing data and/or functionality provided by application resources 116. Network 104 may be a local network, such as a LAN, or a wide area network, such as the Internet and/or a cellular network. In some embodiments, network 104 is comprised of several discrete networks and/or sub-networks (e.g., cellular to Internet) that enable communication between the components 102, 106, 116 of system 100.

Token management service 106 comprises a combination of hardware, including one or more special-purpose processors and one or more physical memory modules, and specialized software modules (such as token manager 108, credentials manager 110 and sidecar API 112) that are executed by the one or more processors to perform functions associated with centralized access token management in a distributed service computing architecture as described herein. In some embodiments, token management service 106 is a logical computing device that comprises a plurality of distributed hardware and software resources (e.g., arranged in a cloud computing environment) which provide the described functions. In some embodiments, token management service 106 is a physical computing device (e.g., a server) coupled to application services 102, authentication service, and application resources 116. In some embodiments, token management service 106 can communicate with the other components of system 100 via one or more APIs as described herein. Generally, an API is a collection of functions, procedures, definitions, and protocols that enable integration of application software. API requests and responses can be exchanged between application services 102, token manager 108, credentials manager 110, sidecar API 112, authentication service 114, and application resources 116, using any of a number of different architectures, including but not limited to: Representational State Transfer (REST) or Simple Object Access Protocol (SOAP). In one implementation of the REST architecture that can be used in system 100, for example, resources are accessed using Uniform Resource Identifiers (URIs) and requests/responses are exchanged using Hypertext Transfer Protocol (HTTP). For example, an application service 102a (e.g., a single page application or backend service) can communicate with token management service 106 by making Transport Layer Security (TLS)-encrypted REST/HTTP calls using an API key or client certificate.

As described above, token management service 106 includes token manager 108, credentials manager 110, and sidecar API 112. In some embodiments, token manager 108, credentials manager 110, and sidecar API 112 are specialized sets of computer software instructions programmed onto one or more dedicated processors associated with token management service 106 and can include designated memory locations and/or registers for executing the specialized computer software instructions. Generally, although token manager 108, credentials manager 110, and sidecar API 112 are shown in FIG. 1 as executing within the same token management service, in some embodiments the functionality of token manager 108, credentials manager 110, and sidecar API 112 can be distributed among one or a plurality of other computing devices that are coupled to token management service 106. It should be appreciated that any number of computing devices, arranged in a variety of architectures, resources, and configurations (e.g., cluster computing, virtual computing, cloud computing) can be used without departing from the scope of the invention. Further explanation of the specific processing performed by token manager 108, credentials manager 110, and sidecar API 112 is throughout the specification.

Authentication service 114 is a computing device or a plurality of computing devices that provide token generation and rotation services to token manager 108 of token management service 106 via sidecar API 112. In some embodiments, sidecar API 112 connects to authentication service 114 in order to generate, rotate, and/or invalidate access tokens that are used by token manager 108 for authentication of application services 102 to access application resources 116. An exemplary authentication service 114 is based upon the OAuth 2.0 (Open Authorization) platform. It should be appreciated that other authentication methods or frameworks can be used by authentication service 114 without departing from the scope of technology described herein.

Application resources 116 are computing devices that provide application-related functionality and/or data to application services 102 upon request. In some embodiments, application resources 116 can receive access requests from application services 102 and process the access requests. For example, an access request may comprise instructions to store/retrieve/update/delete data, execute one or more transactions, generate reports, and the like. The application resource 116 that receives the access request can process the instructions and perform one or more functions in order to respond to the access request with the desired resources.

In some embodiments, all or a portion of the functionality of application services 102, token management service 106, authentication service 114, and application resources 116 can be implemented in a distributed computing environment, such as a cloud computing environment. In exemplary embodiments, application services 102 are located in one or more first physical geographic locations (geolocations) that are different from one or more other geolocation(s) at which token management service 106, authentication service 114, and application resources 116 are located. Exemplary platforms that can be used for the cloud computing environment include, but are not limited to, Amazon® Web Services (AWS); IBM® Cloud™; and Microsoft® Azure™. It should be appreciated that other types of computing resource distribution and configuration can be used within the scope of the technology described herein.

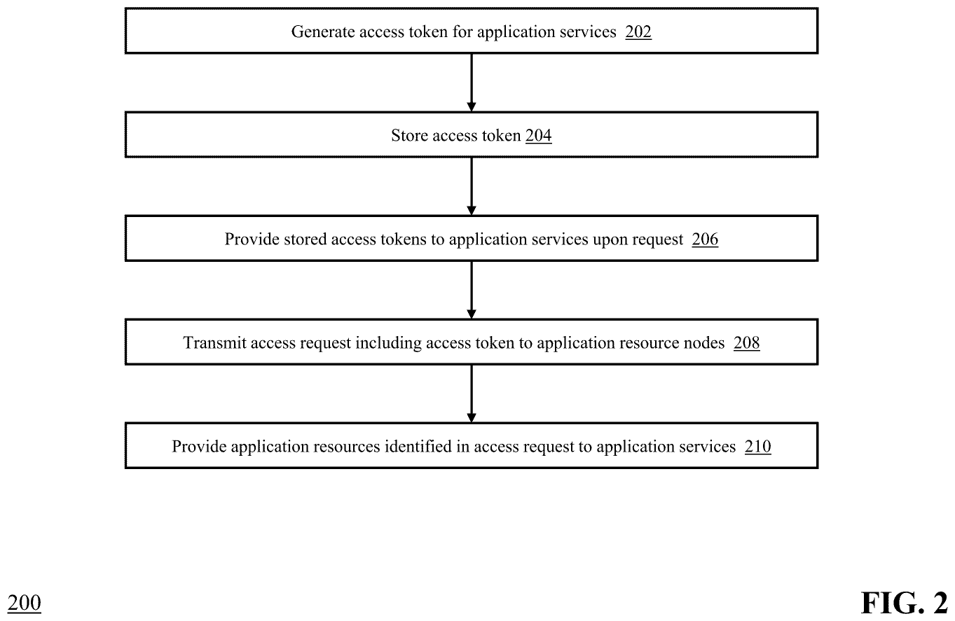

FIG. 2 is a flow diagram of a computerized method 200 of centralized access token management in a distributed service computing architecture, using system 100 of FIG. 1. As mentioned above, a user at an endpoint computing device can establish a communication session with one or more application services 102 in order to access and interact with data and functionality provided by application resources 116. As one example, a user at device 102 may be a customer of the organization (e.g., financial institution) that operates an application service 102a and the user initiates a connection to the application service 102a to view their current retirement savings account balances. In another example, a user at the endpoint computing device may be an employee of the organization that operates application service 102a and the user initiates a connection to the application service 102a to interact with specific data that relates to their job responsibilities. To respond to user requests and/or interactions, the application service 102a may require access to one or more application resources 116, which in turn necessitates that the application service 102a is properly authenticated using the token infrastructure described herein before the service 102a is allowed to access the resources 116.

To perform authentication of application services 102, token management service 106 is configured to generate (step 202), in conjunction with authentication service 114, an access token for each application service 102 using authentication credentials associated with the corresponding application service. In some embodiments, token manager 108 generates an access token for a given application service 102a by requesting the access token from the authentication service 114 using one or more authentication credentials associated with the application service. In one example, when an application service 102a is onboarded or deployed, authentication credentials (e.g., client ID, client secret) associated with the service 102a are stored in credentials manager 110. In some embodiments, the authentication credentials are stored in association with, e.g., an identifier of the application service 102a to which the credentials pertain. Once the authentication credentials have been stored, token manager 108 connects to authentication service 114 and sends a token generation request to authentication service 114, where the token generation request includes the authentication credentials for the corresponding application service 102a. In one example, the token generation request is a function executed by token manager 108—e.g.:
generateTokenForAppName(<appName>): <credentials>
where <appname> comprises the application service identifier for application service 102a and <credentials> comprises the authentication credentials for application service 102a. Upon receiving the token generation request, authentication service 116 generates a new access token for the application service 102a and returns the access token to token manager 108. Token manager 108 invokes sidecar API 112 to transmit the access token to credential manager 110 and store the token in credential manager 110 (step 204). Generally, the access token (or authentication token) comprises a unique piece of information (e.g., a string) that determines specific resource(s) that the application service is allowed to access. In some embodiments, each application service 102 has a single access token stored in credentials manager 110 for access to a plurality of application resources 116. In some embodiments, each application service 102 has a plurality of access tokens, e.g., one token for each different application resource 116 being accessed.

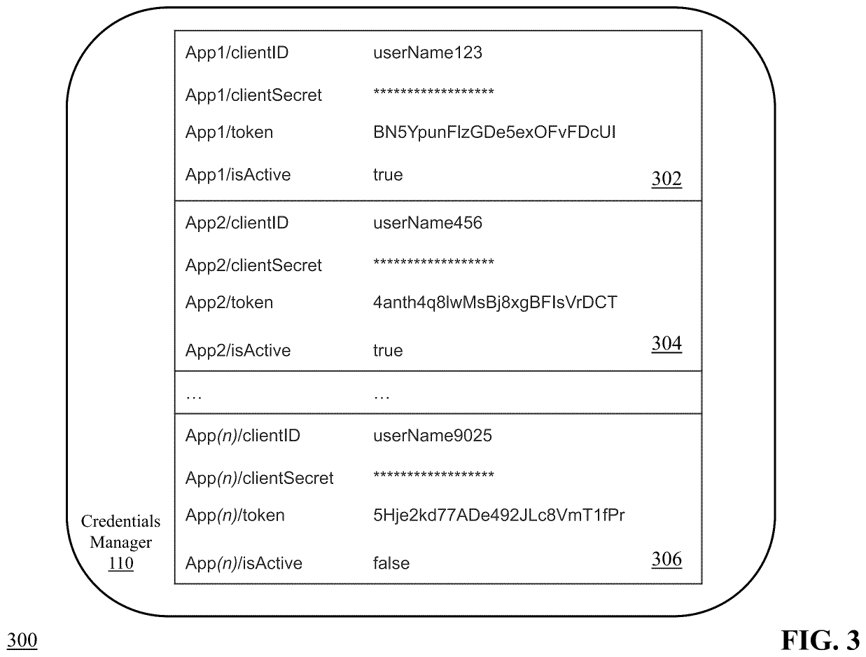

FIG. 3 is a diagram of an exemplary storage area 300 in credentials manager 110 for authentication credentials and access tokens. As shown in FIG. 3, credentials manager 110 stores a data structure (e.g., 302, 304, 306) for each application service 102 that includes the client ID, the client secret, the access token, and an active flag for a plurality of application services 102. In some embodiments, the access token is stored as a key-value pair, i.e., a key of <App1/token> and a value comprising the token value (e.g., BN5YpunFlzGDe5exOFvFDcUI). In some cases, the token value is encrypted. In some embodiments, the access token is stored as JavaScript Object Notation (JSON) data including one or more of a timestamp, a token validity, and an environment associated with the access token. In some embodiments, the active flag denotes whether the authentication credentials and token are active for a given application service 102. In one example, if token manger 108 encounters any errors while generating a token by invoking sidecar API 112 and requesting a new access token from authentication service 114, token manager 108 can invalidate the authentication credentials by setting the active flag to false. Invalidated credentials associated with application services 102 are skipped when token manager 108 performs the functions of token generation and rotation as described herein.. An exemplary function for credentials invalidation executed by token manager 108 is e.g., invalidateCredentialsForAppName(<appName>) where <appname> comprises the application identifier for the application service 102. Exemplary software that can be used to implement credentials manager 110 includes, but is not limited to, HashiCorp Vault™ available from HashiCorp, Inc., AWS Secret Manager™ available from Amazon, Inc. ; and Spring Cloud Config Server™ available from spring. io.

Advantageously, token manager 108 communicates with credentials manager 110 using sidecar API 112. In some embodiments, sidecar API 112 can be invoked by either token manager 108 or credentials manager 110 asynchronously to rotate access tokens—instead of requiring the application services 102 to request/refresh an access token from token manager 108 during the process of establishing a connection to application resources 116, which could significantly delay the connection process and result in increased bandwidth and resource consumption due to the additional API calls being made. In some embodiments, sidecar API 112 comprises a programmed software interface (e.g., Java, Python) that defines certain function calls and data parameters that can be exchanged between token manager 108 and credentials manager 110.

In some embodiments, the authentication credentials are isolated from application services 102 by storing the authentication credentials associated with the application services 102 in the credential manager 110 and restricting the application services 102 access to only the access token, to thereby reduce the risk of accidental exposure and increase the security of the system. For example, when an application service 102a requests an access token, the application service 102 does not need to access or handle the authentication credentials—only the access token stored in credentials manager 110. In this way, the authentication credentials remain securely stored in credentials manager 110 without unnecessary access by other components of the system and endpoints/application services 102 are authenticated seamlessly without exposing the credentials.

The asynchronous communication enabled by sidecar API 112 results in an improved process for token generation, rotation, and invalidation in the context of system 100. For example, token manager 108 can be configured to rotate tokens stored in credentials manager 110 according to a defined schedule without impacting the continued ability for application services 102 to authenticate to and access application resources 116. In another example, token manager 108 can be configured to evaluate existing access tokens stored in credentials manager 110 (e.g., to determine whether the tokens will expire), invalidate any active tokens that will expire, and generate new tokens using authentication service 114 for storage in credentials manager 110. For example, token manager 108 can determine that a token will expire within a predetermined amount of time (e.g., second(s), minute(s), hour(s), day(s)). Token manager 108 can proactively invalidate these tokens and generate new tokens to ensure uninterrupted availability for application services 102 to access application resources 116. Additional detail about the operation of sidecar API 112 by token manager 108 and credentials manager 110 is provided later in the specification.

As mentioned above, when application services 102 initiate a request to access certain application resources 116, the application services 102 must be authenticated using the token(s) stored in credentials manager 110 before the application resources 116 are made available. In some embodiments, each application service 102a-102n establishes a connection to credentials manager 110 in token management service 106 to request the stored access token associated with the respective service 102a-102n. As part of the access token request, the application service 102a-102n provides, e.g., an application client ID and/or other identifier to credentials manager 110. Credentials manager 110 identifies the access token associated with the requesting service 102a-102n and provides (step 206 of FIG. 2) the stored access token to the service 102a-102n in response to the access token request. As can be appreciated, credentials manager 110 can simply retrieve the stored token and provide the token to the service 102a-102n, rather than having to make separate, additional API calls to, e.g., token management service 106 and/or authentication service 114 to generate and/or validate the access token, because the access token has already been generated/validated and stored in credentials manager 110 using token manager 108 and sidecar API 112 as described above.

Once the application service 102a-102n receives the stored access token from credentials manager 110, the application service 102a-102n transmits (step 208) an access request, including the access token received from credentials manager 110, to one or more application resource nodes 116. After receiving the access request, the application resource nodes 116 provide (step 210) one or more resources to the requesting application service 102a-102n. In some embodiments, the access request includes instructions or data elements that identify specific resources requested from the application resources 116—e.g., queries, data, parameters, transaction execution, etc. In some embodiments, the application resource nodes 116 can validate the access token and return a message to the application service 102a-102n in response to the access request. For example, application resources 116 can transmit a validation request to authentication service 114 that includes the access token from the application service 102a-102n. Authentication service 114 can confirm that the access token is valid and return a corresponding message to application resources 116. After receiving the confirmation, application resources 116 can process the access request and transmit the requested resources to application services 102a-102n.

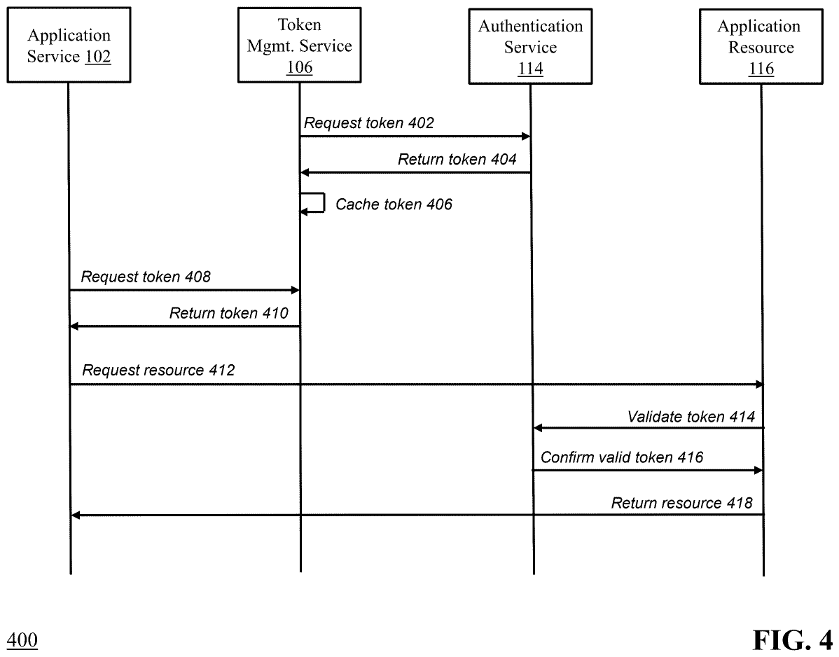

FIG. 4 is a ladder diagram of a computerized workflow 400 for generation and storage of access tokens, using system 100 of FIG. 1. As shown in FIG. 4, token management service 106 (specifically, token manager 108) periodically requests (402) access tokens from authentication service 114 to be used for authentication of application services 102. As can be appreciated, the frequency of the access requests (402) can be tied to the lifetime of the access token. Authentication service 114 returns (404) the access tokens to token management service 106 (specifically, token manager 108) which invokes sidecar API 112 to transmit the access tokens to credentials manager 110 where the tokens are cached (406). It should be appreciated that steps 402 to 406 of FIG. 4 can happen asynchronously from the remaining steps 408 to 418—meaning that steps 402 to 406 can occur at a first time (e.g., prior to application service 102 initiating communication with token management service 106 and/or application resource 116), while steps 408 to 418 can occur at a second time. In this context, the generation and storing of the access token (steps 402 to 406) occur independently of providing the access token to application service 102 in response to an access request (steps 408 to 418).

When application service 102 initiates a request to access resources provided by application resource 116, application service 102 requests (408) the access token from token management service 106 (specifically, credential manager 110). Credential manager 110 returns (410) the access token to the application service 102. Application service 102 then requests (412) access to application resource 116, where the request transmitted from service 102 to resource 116 includes the access token.

Application resource 116 validates (414) the access token received from application service 102 by requesting validation from authentication service 114, including passing the access token to authentication service 114. Authentication service 114 confirms (416) that the access token is valid and returns a message back to application resource 116, which then returns (418) a message to application service 102 granting access to the resource 116.

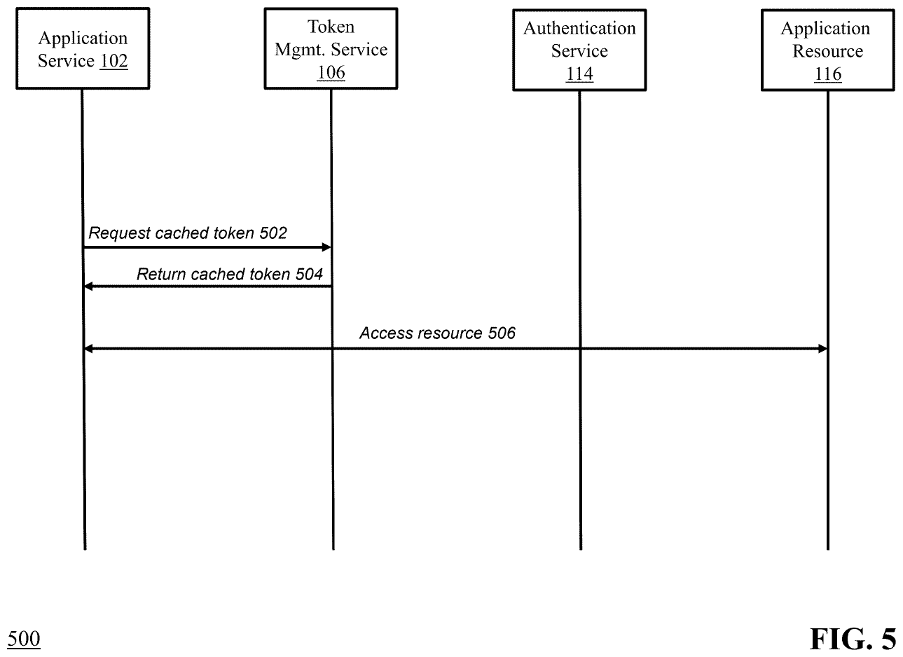

FIG. 5 is a ladder diagram of a computerized workflow 500 for accessing application resources using a cached access token, using system 100 of FIG. 1. The process of generating and storing an access token (steps 402 to 406 of FIG. 4) are not included in FIG. 5; it should be understood that an access token is already cached in credential manager 110 for application service 102. Application service 102 initiates a request to access application resource 116, and requests (502) the cached access token from token management service 106 (specifically, credential manager 110). Credential manager 110 returns (504) the cached token to application service 102, which then accesses (506) the desired application resource 116 using the access token. Importantly, application service 102 does not need to make separate API calls to authentication service 114 and/or token management service 106 to generate/store an access token, thereby saving processing resources and time during the authentication and access process.

In addition to generating access tokens for use by application services 102a-102n, token manager 108 and sidecar API 112 can be used to rotate, invalidate, and refresh access tokens stored in credentials manager 110. As can be appreciated, the access tokens will typically expire after a defined period of time (e.g., seconds, minutes, hours, etc.). For example, when creating an access token, authentication service 114 can assign an expiration date/time to the access token. Once a token has expired, the token cannot be used to access the desired resources. Authentication service 114 will return a message that the access token is invalid upon receiving a validation request from another computing device. In some embodiments, token manager 108 is configured to periodically execute a function (e.g., cron job) that rotates the access tokens currently stored in credentials manager 110 to avoid the issue of expired access tokens being provided to application services 102. An exemplary function for token rotation executed by token manager 108 is, e.g., rotateAllTokens( ). When executing this function, token management service 106 requests (via sidecar API 112) the authentication credentials associated with each access token stored in credentials manager 110 and issues a corresponding token rotation request to authentication service 114. Upon receiving each token rotation request, authentication service 114 generates a new token, and returns the new token to token manager 108. Token manager 108 can then call sidecar API 112 to transmit the new token back to credentials manager 110 for storage.

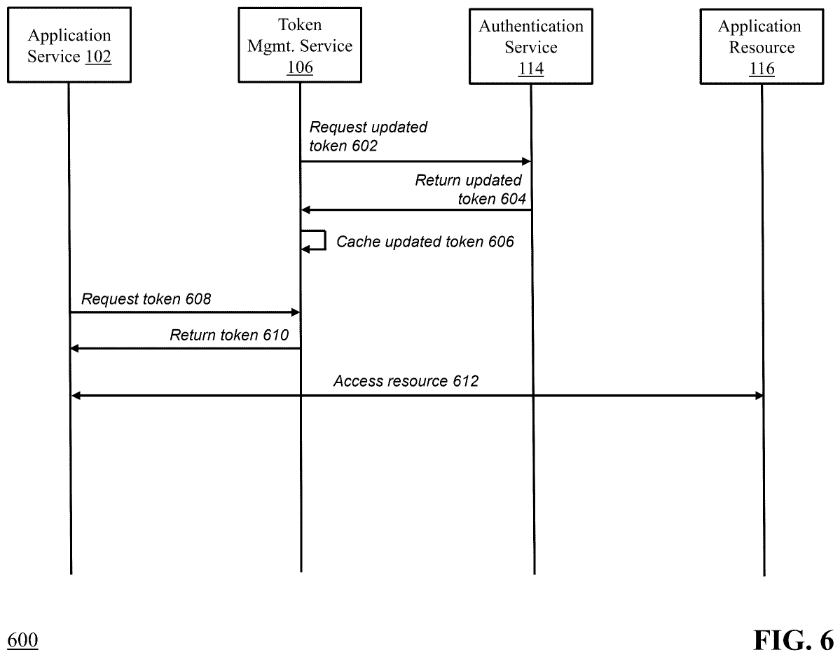

FIG. 6 is a ladder diagram of a computerized workflow 600 for refreshing cached access tokens, using system 100 of FIG. 1. As shown in FIG. 6, token management service 106 (specifically, token manager 108) periodically requests (602) updated access tokens from authentication service 114 (also called rotating the access tokens) to be used for authentication of application services 102. Authentication service 114 returns (604) the updated access tokens to token management service 106 (specifically, token manager 108) which invokes sidecar API 112 to transmit the updated access tokens to credentials manager 110 where the updated tokens are cached (606). It should be appreciated that steps 602 to 606 of FIG. 6 can happen asynchronously from the remaining steps 608 to 612—meaning that steps 602 to 606 can occur at a first time (e.g., prior to application service 102 initiating communication with token management service 106 and/or application resource 116), while steps 608 to 612 can occur at a second time. In this context, the rotation of the access token (steps 602 to 606) occurs independently of providing the access token to application service 102 in response to an access request (steps 608 to 612).

When application service 102 initiates a request to access resources provided by application resource 116, application service 102 requests (608) an access token from token management service 106 (specifically, credential manager 110). Credential manager 110 returns (610) the updated access token to the application service 102. Application service 102 then requests (612) access to application resource 116, where the request transmitted from service 102 to resource 116 includes the updated access token.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for centralized access token management in a distributed service computing architecture, the system comprising:
a plurality of application services, each application service associated with a different application,
an authentication service node,
a token management node,
a credentials management node,
a software interface connecting the credentials management node to the token management node, and
a plurality of application resource nodes,
wherein the token management node:
generates an access token for each of the plurality of application services by requesting the access tokens from the authentication service node using one or more authentication credentials associated with each of the application services,
stores the access tokens in the credentials management node using the software interface,
wherein the credentials management node:
provides the stored access tokens to the plurality of application services upon request, including receiving an access token request from a first one of the application services and transmitting a first access token associated with the first application service in response to the access token request;
wherein upon receiving the first access token from the credentials management node, the application service transmits an access request to one of the application resource nodes that includes the first access token; and
wherein upon receiving the access request from the first application service, the application resource node provides one or more resources identified in the access request to the first application service.

2. The system of claim 1, wherein the token management node generates and stores the access tokens for each of the plurality of application services independently from the credentials management node receiving the access token requests from each of the application services.

3. The system of claim 2, wherein the token management node generates the access tokens periodically according to a defined schedule using authentication credentials stored in the credentials management node.

4. The system of claim 1, wherein upon receiving the access request from the first application service, the application resource node validates the first access token prior to providing the one or more resources identified in the access request to the first application service.

5. The system of claim 4, wherein the application resource node validates the first access token by transmitting a validation request including the first access token to the authentication service node.

6. The system of claim 1, wherein the token management node periodically rotates each of the access tokens stored in the credentials management node by generating a new access token for each of the plurality of application services, wherein the token management node requests the new access token from the authentication service node via the software interface using the one or more authentication credentials associated with each of the application services and stores the new access tokens in the credentials management node.

7. The system of claim 1, wherein the token management node periodically determines whether each of the access tokens stored in the credentials management node will expire based upon a timestamp associated with each of the access tokens.

8. The system of claim 7, wherein when the token management node determines that an existing access token stored in the credentials management node will expire, the token management node deletes the existing access token from the credentials management node and generates a new access token by requesting the new access token from the authentication service node.

9. The system of claim 1, wherein the one or more authentication credentials associated with each of the application services comprise a client identifier and a client secret.

10. The system of claim 9, wherein the one or more authentication credentials associated with each of the application services are stored in the credentials management node in isolation from the access tokens.

11. The system of claim 1, wherein the access tokens are stored as key-value pairs in the credentials management node.

12. The system of claim 1, w herein the access tokens are stored as JavaScript Object Notation (JSON) data including one or more of a timestamp, a token validity, and an environment.

13. A computerized method of centralized access token management in a distributed service computing architecture, the method comprising:
generating, by a token management node, an access token for each of a plurality of application services by requesting the access tokens from an authentication service node using one or more authentication credentials associated with each of the application services;
storing, by the token management module, the access tokens in a credentials management node using a software interface that connects the token management module to the credentials management module; and
providing, by the credentials management node, the stored access tokens to the plurality of application services upon request, including receiving an access token request from a first one of the application services and transmitting a first access token associated with the first application service in response to the access token request;
wherein upon receiving the first access token from the credentials management node, the application service transmits an access request to one of the application resource nodes that includes the first access token; and
wherein upon receiving the access request from the first application service, the application resource node provides one or more resources identified in the access request to the first application service.

14. The method of claim 13, wherein the token management node generates and stores the access tokens for each of the plurality of application services independently from the credentials management node receiving the access token requests from each of the application services.

15. The method of claim 14, wherein the token management node generates the access tokens periodically according to a defined schedule using authentication credentials stored in the credentials management node.

16. The method of claim 13, wherein upon receiving the access request from the first application service, the application resource node validates the first access token prior to providing the one or more resources identified in the access request to the first application service.

17. The method of claim 16, wherein the application resource node validates the first access token by transmitting a validation request including the first access token to the authentication service node.

18. The method of claim 13, wherein the token management node periodically rotates each of the access tokens stored in the credentials management node by generating a new access token for each of the plurality of application services, wherein the token management node requests the new access tokens from the authentication service node via the software interface using the one or more authentication credentials associated with each of the application services and stores the new access tokens in the credentials management node.

19. The method of claim 13, wherein the token management node periodically determines whether each of the access tokens stored in the credentials management node will expire based upon a timestamp associated with each of the access tokens.

20. The method of claim 19, wherein when the token management node determines that an existing access token stored in the credentials management node will expire, the token management node deletes the existing access token from the credentials management node and generates a new access token by requesting the new access token from the authentication service node.

21. The method of claim 13, wherein the one or more authentication credentials associated with each of the application services comprise a client identifier and a client secret.

22. The method of claim 21, wherein the one or more authentication credentials associated with each of the application services are stored in the credentials management node in isolation from the application services.

23. The method of claim 13, wherein the access tokens are stored as key-value pairs in the credentials management node.

24. The method of claim 13, wherein the access tokens are stored as JavaScript Object Notation (JSON) data including one or more of a timestamp, a token validity, and an environment.
